(19) United States
(12) Patent Application Publication
(10) Pub. No.: US 2018/0056400 A1
(43) Pub. Date: Mar. 1, 2018

(54) Method of Drilling Hole and Coolant Used In Hole Drilling Work

(71) Applicant: KABUSHIKI KAISHA MIYANAGA, Miki-shi (JP)

(72) Inventor: Masaaki Miyanaga, Miki-shi (JP)

(73) Assignee: KABUSHIKI KAISHA MIYANAGA, Miki-shi (JP)

(21) Appl. No.: 15/660,515

(22) Filed: Jul. 26, 2017

(30) Foreign Application Priority Data
Jul. 27, 2016 (JP) 2016-146936

(51) Int. Cl. B23B 27/10; B23B 27/20; B28D 1/14

(52) U.S. Cl. CPC B23B 27/10; B23B 27/20; B23B 45/02; B23B 2226/31; B23B 2250/12; B28D 1/146

(57) ABSTRACT

Provided is a method of drilling a hole in a drilling object by using a hole drilling device 1 including: a drill bit 3 including a cutting edge on a distal end thereof; and an electric drill 2, which rotates the drill bit 3, the method including a cutting step of rotating the drill bit 3 to drill a hole in the drilling object in a state where a water-soluble gel coolant is applied to the distal end of the drill bit 3.

### BACKGROUND OF THE INVENTION

### 1. Field of the Invention

The present invention relates to a method of drilling a hole by using a hole drilling device capable of drilling a hole in concrete or the like, and also relates to a coolant used in the hole drilling.

### 2. Description of the Related Art

Conventionally, an electric drill has been used as an electric tool of a hole drilling device with which to drill a hole in a drilling object, such as concrete, stone, tile, etc. Such a hole drilling device is configured such that a drill bit is fixed to the chuck of the electric drill, and the electric drill rotates the drill bit to drill a hole in the drilling object.

There is a drill bit with cutting edges that are fixed to the distal end of the drill bit and that are made of grinding stone containing diamond particles. In the case of performing cutting with such a drill bit, since diamond is weak to heat, it is common to perform the cutting while feeding a coolant such as water to the cutting edge portion on the distal end of the drill bit.

For example, Japanese Laid-Open Patent Application Publication No. 2011-37210 discloses a configuration in which a coolant that is a liquid mixture of water and a water-soluble organic solvent is fed to the cutting edge portion of a drill bit (i.e., a wet type configuration). This configuration requires means for feeding the coolant. This configuration also requires means for collecting the coolant in order to prevent the coolant from splashing out and making the surroundings dirty. Thus, in the case of adopting the wet type configuration, the configuration is complex since it requires the coolant feeding means and coolant collecting means.

Meanwhile, Japanese Laid-Open Patent Application Publication No. 2011-136530 discloses a configuration in which no coolant is used (i.e., a dry type configuration).

### SUMMARY OF THE INVENTION

As described above, the wet type configuration requires coolant feeding means and coolant collecting means, and thus the configuration is complex. On the other hand, in the case of adopting the dry type configuration, although the configuration is simple, in general, the rotational speed of the drill bit in the dry type configuration is lower than that in the wet type configuration in order to reduce the generation of heat so that damage to the cutting edges containing diamond, which is weak to heat, will be reduced. For this reason, the work time is prolonged in the case of adopting the dry type configuration.

The present invention has been made to solve the above-described problems. An object of the present invention is to provide a method of drilling a hole and a coolant that make it possible to reduce dirt around a drilled portion and shorten a work time by using a hole drilling device with a simple configuration.

In order to achieve the above object, a method of drilling a hole according to one aspect of the present invention is a method of drilling a hole in a drilling object by using a hole drilling device including: a drill bit including a cutting edge on a distal end thereof; and a handheld electric tool that rotates the drill bit. The method includes a cutting step of rotating the drill bit to drill a hole in the drilling object in a state where a water-soluble gel coolant is applied to the distal end of the drill bit.

According to this method, since the coolant is a gel coolant, the coolant can be readily applied to the distal end of the drill bit. Since the hole drilling is performed in a state where the coolant is applied to the distal end of the drill bit, even if the rotational speed of the drill bit is high, the cutting edge on the distal end of the drill bit can be prevented from being overheated and damaged. This makes it possible to shorten the work time. Since the coolant is not a liquid coolant but a gel coolant, the usage amount of the coolant can be kept small, and dirt around the drilled portion can be reduced. Moreover, since the coolant is water-soluble, after the hole drilling is ended, the coolant remaining at the drilled portion can be readily wiped off with water-wetted cloth or the like, and thereby cleaning can be readily performed. Therefore, by using the hole drilling device with the simple configuration, which does not include, for example, coolant collecting means such as one used in a conventional wet type configuration, dirt around the drilled portion can be reduced, and the work time can be shortened.

The method may further include a coolant feeding step of applying the coolant to the distal end of the drill bit. The coolant feeding step may be performed before the cutting step or during the cutting step.

Preferably, a major component of the coolant is a water-soluble organic solvent, and the coolant preferably contains a hydrophilic polymeric compound as a thickener.

The cutting edge on the distal end of the drill bit may be made of grinding stone containing diamond particles. The present method of drilling a hole is suitable for drilling a hole by using the drill bit that includes the cutting edge containing diamond particles, which are weak to heat.

A coolant according to another aspect of the present invention is a water-soluble gel coolant that is applied to a distal end of a drill bit when the drill bit, which includes a cutting edge on the distal end thereof, is rotated to drill a hole in a drilling object.

Since the coolant is a gel coolant, the coolant can be readily applied to the distal end of the drill bit. Since the hole drilling is performed in a state where the coolant is applied to the distal end of the drill bit, even if the rotational speed of the drill bit is high, the cutting edge on the distal end of the drill bit can be prevented from being overheated and damaged. This makes it possible to shorten the work time. Since the coolant is not a liquid coolant but a gel coolant, the usage amount of the coolant can be kept small, and dirt around the drilled portion can be reduced. Moreover, since the coolant is water-soluble, after the hole drilling is ended, the coolant remaining at the drilled portion can be readily wiped off with water-wetted cloth or the like, and thereby cleaning can be readily performed. Therefore, by using the hole drilling device with the simple configuration, which does not include, for example, coolant collecting means such as one used in a conventional wet type configuration, dirt around the drilled portion can be reduced, and the work time can be shortened.

The present invention is configured as described above, and has an advantage of being able to provide a method of drilling a hole and a coolant that make it possible to reduce dirt around a drilled portion and shorten a work time by using a hole drilling device with a simple configuration.

### BRIEF DESCRIPTION OF THE DRAWINGS

FIG. 1 shows one example of a hole drilling device and others that are used for performing a method of drilling a hole according to one embodiment of the present invention.

FIG. 2A is an exploded view showing one example of a drill bit of the hole drilling device; FIG. 2B is a view taken along line X-X of FIG. 2A as viewed in the direction of the arrows of line X-X; and FIG. 2C is a sectional view taken along line Y-Y of FIG. 2A.

FIG. 3 is a flowchart showing one example of work steps of the method of drilling a hole according to the embodiment.

### DESCRIPTION OF THE PREFERRED EMBODIMENTS

Hereinafter, a preferred embodiment of the present invention is described with reference to the drawings. In the drawings, the same or corresponding elements are denoted by the same reference signs, and repeating the same descriptions is avoided below. The present invention is not limited to the embodiment described below.

### Embodiment

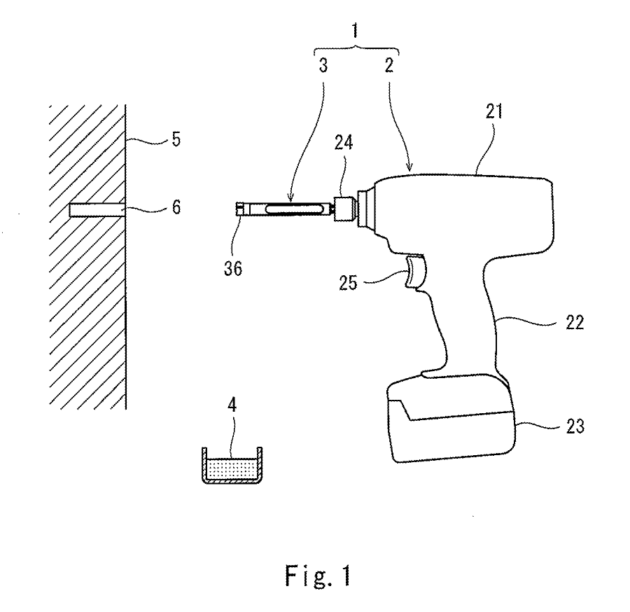

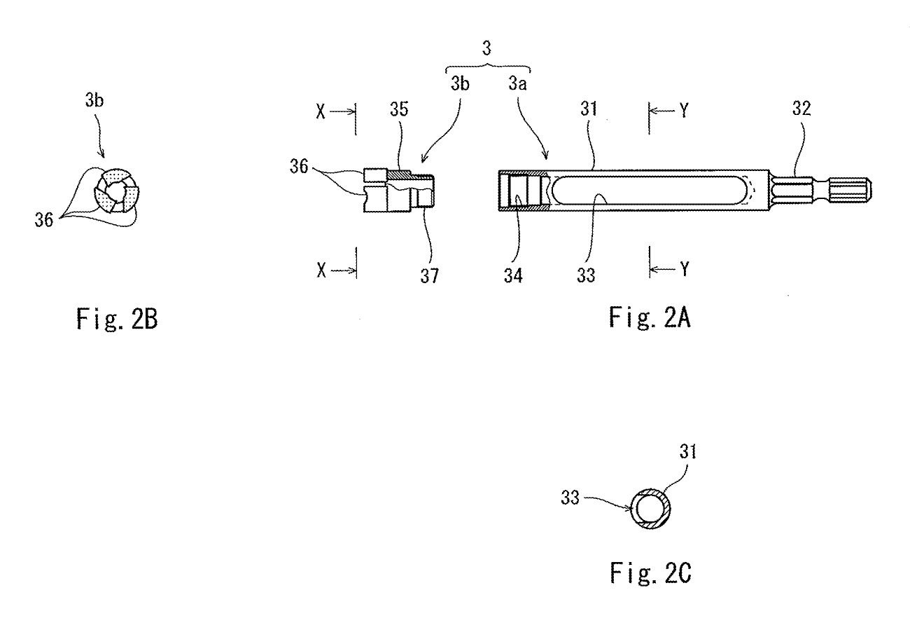

FIG. 1 shows one example of a hole drilling device and others that are used for performing a method of drilling a hole according to the embodiment of the present invention. FIG. 2A is an exploded view showing one example of a drill bit of the hole drilling device. FIG. 2B is a view taken along line X-X of FIG. 2A as viewed in the direction of the arrows of line X-X. FIG. 2C is a sectional view taken along line Y-Y of FIG. 2A.

A hole drilling device 1 shown in FIG. 1 is a handheld device, which a worker holds with his or her hand and with which the worker performs hole drilling work. The hole drilling device 1 includes an electric drill 2 and a drill bit 3.

The electric drill 2 is a handheld electric tool. For example, a well-known tool, such as an impact driver or drill driver, may be adopted as the electric drill 2. In the example shown in FIG. 1, the electric drill 2 includes: a body 21; a grip 22, which is connected to the body 21 and held by a worker with his or her hand; and a battery housing 23 connected to the grip 22. The body 21 is provided with a chuck 24, to which the drill bit 3 is attached. The body 21 accommodates, for example, a motor that rotates the drill bit 3. The battery housing 23 accommodates, for example, a battery that supplies electric power to the motor. The grip 22 is provided with a trigger switch 25. The worker operates the trigger switch 25, for example, to start or stop the rotation of the drill bit 3 driven by the motor.

As shown in FIG. 2A, for example, the drill bit 3 includes a shaft 3a and a cutting edge replacement portion 3b. The shaft 3a includes: a cylindrical portion 31, which is long, rod-shaped, and circular cylindrical; and a shank 32 detachably attached to the chuck 24 of the electric drill 2, the shank 32 being formed at the proximal end side of the shaft 3a. An elongated core discharge window 33 is formed in the side surface of the cylindrical portion 31. A female screw portion 34, to which the cutting edge replacement portion 3b is to be attached, is formed on the inner wall of the distal end portion of the cylindrical portion 31.

The cutting edge replacement portion 3b includes: a cylindrical portion 35, which is short and circular cylindrical; and a plurality of cutting edges 36 fixed to the distal end of the cylindrical portion 35. The plurality of (in the example of FIG. 2B, three) cutting edges 36 are arranged around an opening formed in the distal end of the cylindrical portion 35, and are made of segment grinding stone containing diamond particles. Each cutting edge 36 is formed, for example, by melting and fusing multiple layers of diamond abrasive grains together.

A male screw portion 37, which is screwed into the female screw portion 34 of the shaft 3a, is formed on the outer wall of the proximal end portion of the cylindrical portion 35. Accordingly, by screwing the male screw portion 37 into the female screw portion 34, the cutting edge replacement portion 3b is fixed to the distal end of the shaft 3a, and by unscrewing the male screw portion 37 from the female screw portion 34, the cutting edge replacement portion 3b is removed from the shaft 3a. In this manner, the cutting edge replacement portion 3b can be attached to and detached from the shaft 3a. This makes it possible to replace the cutting edge replacement portion 3b when necessary. It should be noted that the shaft 3a and the cutting edge replacement portion 3b may be integrated together.

(Method of Drilling Hole)

Hereinafter, the method of drilling a hole is described. With this method, a hole 6 is drilled in a drilling object 5 by using the above-described hole drilling device 1, for example, as shown in FIG. 1. The drilling object 5 is made of, for example, concrete, stone, tile, or mortar. The drilling object 5 is, for example, a part of a structure such as a wall, floor, or ceiling.

In the present embodiment, the worker holds the hole drilling device 1 with his or her hand, and performs hole drilling work of drilling a hole in a predetermined portion of the drilling object 5 with the hole drilling device 1. At the time, a water-soluble gel coolant 4 is applied to the cutting edges 36 on the distal end of the drill bit 3 before performing the hole drilling work.

The major component of the coolant 4 is, for example, a water-soluble organic solvent such as an alcohol, and the coolant 4 contains a hydrophilic polymeric compound as a thickener. Such coolant 4 may contain, for example, about 80 vol % of ethanol (as the water-soluble organic solvent), and also contain a carboxyvinyl polymer (as the thickener). The coolant 4 may further contain triethanolamine, butylene glycol, allantoin, etc.

The coolant 4 described as above may be a gel coolant with such low viscosity that, at an ordinary temperature, when the distal end of the drill bit 3 is immersed in the coolant 4 in a container and taken out of the coolant 4, the coolant 4 will adhere to the cutting edges 36 on the distal end of the drill bit 3.

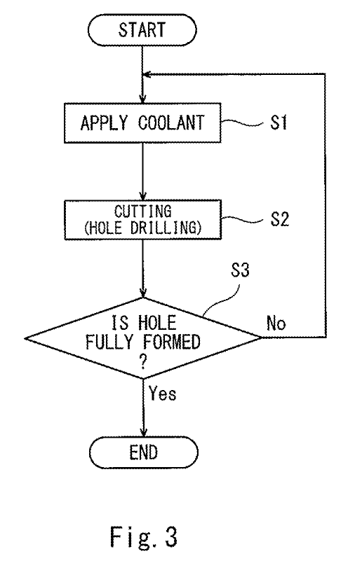

FIG. 3 is a flowchart showing one example of work steps of the method of drilling a hole according to the present embodiment. In the method of drilling a hole, first, the worker immerses the distal end of the drill bit 3 of the hole drilling device 1 into the coolant 4 and then takes it out of the coolant 4, thereby applying the coolant 4 to the cutting edges 36 on the distal end of the drill bit 3 (step S1, a coolant feeding step).

Next, the worker brings the distal end of the drill bit 3 into contact with a predetermined portion of the drilling object 5, in which portion a hole is to be drilled, and then pulls the trigger switch 25 with his or her finger to drive the electric drill 2 (i.e., rotate the drill bit 3), thereby cutting into the drilling object 5 to drill a hole therein (step S2, a cutting step).

The worker repeats the work steps S1 and S2 until determining that the hole has been fully formed (step S3). Here, for the purpose of preventing the cutting edges 36 from being overheated and damaged, the worker performs the hole drilling work, for example, in the following manner: perform hole drilling for several seconds or several tens of seconds; and then, after re-applying the coolant 4 to the cutting edges 36, resume the hole drilling. It should be noted that there may be a case where the hole is fully formed by performing each of step S1 and step S2 only once depending on, for example, the size of the hole.

The present embodiment uses the water-soluble gel coolant 4. Since the coolant 4 is a gel coolant, the coolant 4 can be readily applied to the distal end of the drill bit 3. Since the hole drilling is performed in a state where the coolant 4 is applied to the distal end of the drill bit 3, even if the rotational speed of the drill bit 3 is high, the cutting edges 36 on the distal end of the drill bit 3 can be prevented from being overheated and damaged. This makes it possible to shorten the work time. Since the coolant 4 is not a liquid coolant but a gel coolant, the usage amount of the coolant 4 can be kept small, and dirt around the drilled portion can be reduced.

Moreover, since the coolant 4 is water-soluble, after the hole drilling is ended, the coolant 4 remaining at the drilled portion can be readily wiped off with water-wetted cloth or the like, and thereby cleaning can be readily performed. Therefore, the coolant feeding means and coolant collecting means, which are necessary for a conventional wet type configuration, can be eliminated. By using the hole drilling device 1 with such a simple configuration, dirt around the drilled portion can be reduced, and the work time can be shortened.

In the present embodiment, the coolant feeding step (step S1) and the cutting step (step S2) are performed alternately. However, as an alternative, the hole drilling device 1 may be configured such that the coolant feeding step and the cutting step are performed concurrently, for example, the coolant feeding step may be performed during the cutting step. As one example, the hole drilling device 1 may include coolant feeding means, such as one used in a conventional wet type configuration, and may be configured such that while the drill bit 3 without the core discharge window 33 is rotating (performing cutting), the coolant 4 flows inside the drill bit 3, and a small amount of coolant 4 is intermittently or continuously fed to the distal end of the drill bit 3. As another example, the hole drilling device 1 may be configured such that the inside of the drill bit 3 without the core discharge window 33 is filled with the coolant 4, and while the drill bit 3 is rotating (performing cutting), the coolant 4 is pushed out to the distal end of the drill bit 3. In either case, it is necessary for the hole drilling device 1 to include coolant supplying means. However, it is not necessary for the hole drilling device 1 to include coolant collecting means, such as one used in a conventional wet type configuration.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

### REFERENCE SIGNS LIST

1 hole drilling device
2 electric drill
3 drill bit
4 coolant
5 drilling object
6 hole
36 cutting edge

What is claimed is:

1. A method of drilling a hole in a drilling object by using a hole drilling device including: a drill bit including a cutting edge on a distal end thereof; and a handheld electric tool that rotates the drill bit, the method comprising
a cutting step of rotating the drill bit to drill a hole in the drilling object in a state where a water-soluble gel coolant is applied to the distal end of the drill bit.

2. The method of drilling a hole according to claim 1, further comprising a coolant feeding step of applying the coolant to the distal end of the drill bit, wherein
the coolant feeding step is performed before the cutting step or during the cutting step.

3. The method of drilling a hole according to claim 1, wherein
a major component of the coolant is a water-soluble organic solvent, and
the coolant contains a hydrophilic polymeric compound as a thickener.

4. The method of drilling a hole according to claim 1, wherein
the cutting edge on the distal end of the drill bit is made of grinding stone containing diamond particles.

5. A water-soluble gel coolant that is applied to a distal end of a drill bit when the drill bit, which includes a cutting edge on the distal end thereof, is rotated to drill a hole in a drilling object.
